(19) United States
(12) Patent Application Publication
(10) Pub. No.: US 2021/0163681 A1
(43) Pub. Date: Jun. 3, 2021

(54) METHOD FOR PRODUCING POLYETHER THIOCARBONATE POLYOLS

(71) Applicant: COVESTRO DEUTSCHLAND AG, Leverkusen (DE)

(72) Inventors: Thomas Ernst MUELLER, Aachen (DE); Christoph GÜRTLER, Köln (DE); Muhammad Afzal SUBHANI, Aachen (DE); Fatemeh EBRAHIMI, Aachen (DE); Walter LEITNER, Aachen (DE)

(21) Appl. No.: 16/469,704

(22) PCT Filed: Dec. 18, 2017
(86) PCT No.: PCT/EP2017/083368

§ 371 Date: Jun. 14, 2019

(30) Foreign Application Priority Data
Dec. 19, 2016 (EP) 16205145.2

(51) Int. Cl. C08G 65/26; C08G 64/38; C08G 64/34; C08G 18/79; C08G 18/50

(52) U.S. Cl. CPC C08G 65/2663; C08G 64/38; C08G 65/2603; C08G 2101/00; C08G 18/792; C08G 18/5072; C08G 64/34

(57) ABSTRACT

A process for preparing polyether thiocarbonate polyols comprising the step of reacting carbon disulfide and at least one alkylene oxide in the presence of a double metal cyanide catalyst and at least one H-functional starter compound, wherein before first contact with carbon disulfide the double metal cyanide catalyst has previously been contacted with at least one alkylene oxide the the invention likewise relates to a polyol obtainable by the process according to the invention.

The present invention relates to a process for preparing polyether thiocarbonate polyols comprising the step of reacting carbon disulfide and at least one alkylene oxide in the presence of a double metal cyanide catalyst and at least one starter compound having 2 or more Zerewittinoff active H atoms. Said invention likewise relates to a polyol obtainable by the process according to the invention and also to a polyurethane polymer prepared therewith.

The preparation of polyether carbonate polyols by catalytic reaction of alkylene oxides (epoxides) and carbon dioxide in the presence of H-functional starter compounds (“starters”) has been the subject of intensive study for more than 40 years (e.g. Inoue et al., Copolymerization of Carbon Dioxide and Epoxide with Organometallic Compounds; Die Makromolekulare Chemie 130, 210-220, 1969). This reaction is shown in schematic form in scheme (I), wherein R is an organic radical such as alkyl, alkylaryl or aryl, each of which may also contain heteroatoms, for example O, S, Si, etc., X is O e and f are each integers, and wherein the product shown here in scheme (I) for the polyether carbonate polyol should merely be understood in such a way that blocks having the structure shown may in principle be present in the polyether carbonate polyol obtained, but the sequence, number and length of the blocks and the OH functionality of the starter may vary and is not restricted to the polyether carbonate polyol shown in scheme (I). This reaction (see scheme (I)) is environmentally very advantageous since this reaction constitutes the conversion of a greenhouse gas such as CO₂ to a polymer. A further product, actually a by-product, formed is the cyclic carbonate shown in scheme (I) (for example propylene carbonate when X═O, R═CH₃).

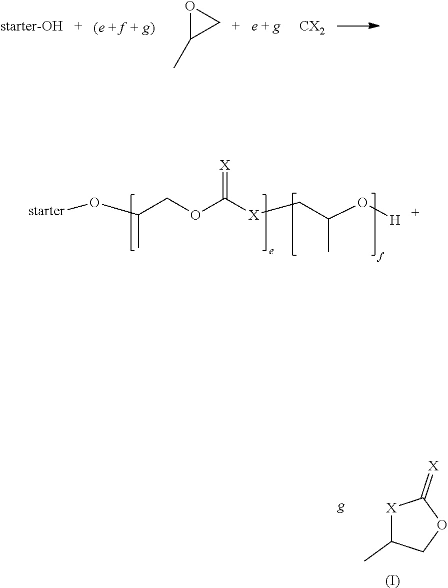

It would be advantageous for certain applications to replace some or all of the carbonate groups present in the polyether carbonate polyol by thiocarbonate groups (scheme (I), X═S).

WO-A 2003/029325 A1 discloses a process for preparing high molecular weight aliphatic polyether carbonate polyols (weight-average molecular weight greater than 30 000 g/mol), in which a catalyst from the group consisting of zinc carboxylate and multimetal cyanide compound is used, this catalyst being anhydrous and first being contacted with at least a portion of the carbon dioxide before the alkylene oxide is added. The use of CS₂ as a co-reagent and the preparation of polyether thiocarbonate polyols are not referred to.

D. J. Darensbourg, S. J. Wilson, A. D. Yeung, Macromolecules 2013, 46, 8102-8110 describes the copolymerization of cyclopentene oxide and carbon disulfide, wherein a scrambling of oxygen and sulfur atoms is observed. The catalyst employed in this publication was a Cr(salen)Cl catalyst.

W. Clegg, R. W. Harrington, M. North, P. Villuendas, J. Org. Chem., 2010, 75, 6201-6207 describes the reaction of alkylene oxide and carbon disulfide, wherein only cyclic thiocarbonates are obtained The employed catalyst was a bimetallic Al(salen) complex.

The publication “Atom-Exchange Coordination Polymerization of Carbon Disulfide and Propylene Oxide by a Highly Effective Double-Metal Cyanide Complex” by Guo-Rong Qi et al., Macromolecules 2008, 41, 1587-1590 in connection with the experimental data available online in the supporting information the copolymerization of the polypropylene glycol PPG-400, propylene oxide and CS₂ in the presence of a DMC catalyst whose composition was determined by elemental analysis to be Zn₃[Co(CN)₆]₂.1.8ZnCl₂.2.3 t-BuOH.3.8H₂O. A solution of PPG-400, propylene oxide, CS₂ and the DMC catalyst was reacted in an autoclave. The authors report an atom-exchange coordination polymerization (AECP). A sulfur-containing polymer having a complex structure was obtained. Structural units present in the polymer are inter alia —O—C(═O)—O— (8.0 mol %), —S—C(═O)—O— (53.6 mol %), —S—C(═O)—S— (17.6 mol %), —S—C(═S)—O— (16.0 mol %) and —S—C(═S)—S— (4.8 mol %). The selectivity (mol %) for linear polyether thiocarbonate polyol over cyclic thiocarbonate was ≤85%.

Polyols comprising sulfur in place of oxygen are of interest for the preparation of materials having a high refractive index. Their hydroxyl groups allow for crosslinking to afford polymers. The refractive index of material is linked to the molecular polarizability. The propagation of light through a dielectric material may be described as the incident light inducing an oscillating dipole moment which in turn radiates light of the same frequency. The newly generated radiation is phase-shifted compared to the incident radiation and it therefore propagates through the medium more slowly than through a vacuum.

Without wishing to be bound to a particular theory it is believed that the easier polarizability of the electron shell of the sulfur is conducive to a higher refractive index compared to materials comprising oxygen atoms at the same location. Likewise important for the size of the dipole moment of a functional group and thus also for the refractive index, however, is the local symmetry of the relevant functional group. The structural unit —S—C(═S)—O— is preferred here. To be avoided are those other structural units which arise on account of atom exchanges in the copolymerization of CS₂ and alkylene oxides.

It is accordingly an object of the present invention to provide a process for preparing polyether thiocarbonate polyols which makes possible catalytic copolymerization of carbon disulfide with alkylene oxides or catalytic terpolymerization of carbon disulfide, alkylene oxides in high yields and which affords a polyol having the highest possible refraction index. It is a specific object of the invention to provide a process for preparing polyether thiocarbonate polyols, wherein a high selectivity for linear polyether thiocarbonate polyols is to be achieved, i.e. a high proportion of linear polyether thiocarbonate polyols (PETC) in relation to cyclic thiocarbonates (CTC). It is also a further object of the invention to achieve a high content of incorporated thiocarbonate groups —S—C(═S)— in the polyol so that the proportion of atom-exchange coordination polymerization and accordingly the proportion of —S—C(═O)— groups is as low as possible.

The object is achieved in accordance with the invention by a process for preparing polyether thiocarbonate polyols comprising the step of reacting carbon disulfide and at least one alkylene oxide in the presence of a double metal cyanide catalyst and at least one H-functional starter compound, wherein before first contact with carbon disulfide the double metal cyanide catalyst has previously been contacted with at least one alkylene oxide.

Because in the process according to the invention the DMC catalyst has previously been contacted with at least one alkylene oxide before first contact with CS₂, an activation of the catalyst takes place. During the activation an exothermic chemical reaction may result in evolution of heat, thus potentially leading to hotspots. The activation step may generally be preceded by a step for drying the DMC catalyst and optionally the H-functional starter compound at elevated temperature and/or reduced pressure, optionally with passage of an inert gas through the reaction mixture.

In the polyether thiocarbonate polyols prepared by the process according to the invention atom exchanges during polymerization are detectable only with difficulty, if at all. This can be verified by IR spectroscopy and in particular by the absence of the typically intense carbonyl bands, it being appreciated that carbon dioxide being a further comonomer here necessitates separate consideration.

As a result of the CS₂ unit being incorporated into the polymer chain without atom exchange, the structural unit —S—C(═S)—O— desirable for a high refractive index of the material, referred to hereinbelow as thiocarbonate groups (—S(C═O)—) promp, may be formed in the polyol.

The process according to the invention may generally employ alkylene oxides (epoxides) having 2-45 carbon atoms. In a preferred embodiment of the process the alkylene oxide is selected from at least one compound from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, epoxides of C6-C22 α-olefins, such as 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, cyclopentene oxide, cyclohexene oxide, cycloheptene oxide, cyclooctene oxide, styrene oxide, methylstyrene oxide, pinene oxide, allyl glycedyl ether, vinylcyclohexene oxide, cyclooctadiene monoepoxide, cyclododecatriene monoepoxid, butadiene monoepoxide, isoprene monoepoxide, limonene oxide, 1,4-divinylbenzene monoepoxide, 1,3-divinylbenzene monoepoxide, glycidyl acrylate and glycidylmethacrylate, mono- or polyepoxidized fats as mono-, di- and triglycerides, epoxidized fatty acids, C1-C24 esters of epoxidized fatty acids, epichlorohydrin, glycidol, and derivatives of glycidol, for example glycidol ethers of C1-C22 alkanols and glycidyl esters of C1-C22 alkanecarboxylic acids. Examples of derivatives of glycidol are phenyl glycidyl ether, cresyl glycidyl ether, methyl glycidyl ether, ethyl glycidyl ether and 2-ethylhexyl glycidyl ether and also epoxy-functional alkyoxysilanes such as 3-glycidyloxypropyl trimethoxysilane, 3-glycidyloxypropyl triethoxysilane, 3-glycidyloxypropyl tripropoxysilane, 3-glycidyloxypropyl methyldimethoxysilane, 3-glycidyloxypropyl ethyldiethoxysilane and 3-glycidyloxypropyl triisopropoxysilane.

Employable as suitable H-functional starter compounds, also known as starters, are compounds having alkoxylation-active H atoms. Alkoxylation-active groups having active H atoms are for example —OH, —NH2 (primary amines), —NH— (secondary amines), —SH, and —CO2H, preference being given to —OH and —NH2, particular preference being given to —OH. As H-functional starter compound at least one compound may for example be selected from the group consisting of mono- or polyhydric alcohols, polyfunctional amines, polyhydric thiols, amino alcohols, thio alcohols, hydroxy esters, polyether polyols, polyester polyols, polyester ether polyols, polyether carbonate polyols, polycarbonate polyols, polycarbonates, polymeric formaldehyde compounds, polyethyleneimines, polyetheramines (for example the products called Jeffamines® from Huntsman, for example D-230, D-400, D-2000, T-403, T-3000, T-5000 or corresponding BASF products, for example Polyetheramine D230, D400, D200, T403, T5000), polytetrahydrofurans (e.g. PolyTHF® from BASF, for example PolyTHF® 250, 650S, 1000, 1000S, 1400, 1800, 2000), polytetrahydrofuranamines (BASF product Polytetrahydrofuranamine 1700), polyether thiols, polyacrylate polyols, castor oil, the mono- or diglyceride of ricinoleic acid, monoglycerides of fatty acids, chemically modified mono-, di- and/or triglycerides of fatty acids, and C1-C24-alkyl fatty acid esters containing an average of at least 2 OH groups per molecule. The C1-C23 alkyl fatty acid esters which contain on average at least 2 OH groups per molecule are, for example, commercial products such as Lupranol Balance® (BASF AG), Merginol® products (Hobum Oleochemicals GmbH), Sovermol® products (Cognis Deutschland GmbH & Co. KG), and Soyol®TM products (USSC Co.).

Monofunctional starter compounds that may be employed include alcohols, amines, thiols and carboxylic acids. Monofunctional alcohols that may be employed include: methanol, ethanol, 1-propanol, 2-propanol, 1-butanol, 2-butanol, tert-butanol, 3-buten-1-ol, 3-Butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Useful monofunctional amines include: butylamine, t-butylamine, pentylamine, hexylamine, aniline, aziridine, pyrrolidine, piperidine, morpholine. Monofunctional thiols that may be used include: ethanethiol, propane-1-thiol, propane-2-thiol, butane-1-thiol, 3-methylbutane-1-thiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols suitable as H-functional starter compounds are, for example, dihydric alcohols (such as, for example, ethylene glycol, diethylene glycol, propylene glycol, dipropylene glycol, 1,3-propanediol, 1,4-butanediol, 1,4-butenediol, 1,4-butynediol, neopentyl glycol, 1,5-pentantanediol, methylpentanediols (such as, for example, 3-methyl-1,5-pentanediol), 1,6-hexanediol; 1,8-octanediol, 1,10-decanediol, 1,12-dodecanediol, bis(hydroxymethyl)cyclohexanes (such as, for example, 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (such as, for example, trimethylolpropane, glycerol, trishydroxyethyl isocyanurate, castor oil); tetrahydric alcohols (such as, for example, pentaerythritol); polyalcohols (such as, for example, sorbitol, hexitol, sucrose, starch, starch hydrolyzates, cellulose, cellulose hydrolyzates, hydroxy-functionalized fats and oils, especially castor oil), and also all modification products of these aforementioned alcohols with different amounts of ε-caprolactone.

The H-functional starter compounds may also be selected from polyether polyols, especially those having a molecular weight Mₙ in the range from 100 to 4000 g/mol. Preference is given to polyether polyols formed from repeating ethylene oxide and propylene oxide units, preferably having a proportion of 35% to 100% propylene oxide units, more preferably having a proportion of 50% to 100% propylene oxide units. These may be random copolymers, gradient copolymers, alternating or block copolymers formed from ethylene oxide and propylene oxide. Suitable polyether polyols constructed from repeating propylene oxide and/or ethylene oxide units are for example the Desmophen®-, Acclaim®-, Arcol®-, Baycoll®-, Bayfill®-, Bayflex®-Baygal®-, PET®- and polyether polyols from Covestro AG (e.g. Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are for example the Pluriol® E brands from BASF SE, suitable homopolypropylene oxides are for example the Pluriol® P brands from BASF SE; suitable mixed copolymers of ethylene oxide and propylene oxide are for example the Pluronic® PE or Pluriol® RPE brands from BASF SE.

The H-functional starter compounds may also be selected from polyester polyols, in particular those having a molecular weight Mₙ in the range from 200 to 4500 g/mol. Polyesters having a functionality of at least two can be used as polyester polyols. Polyester polyols preferably consist of alternating acid and alcohol units. Examples of acid components that may be used include succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride, or mixtures of the recited acids and/or anhydrides. Examples of alcohol components used include ethanediol, 1,2-propanediol, 1,3-propanediol, 1,4-butanediol, 1,5-pentanediol, neopentyl glycol, 1,6-hexanediol, 1,4-bis(hydroxymethyl)cyclohexane, diethylene glycol, dipropylene glycol, trimethylolpropane, glycerol, pentaerythritol, or mixtures of the stated alcohols. Employing dihydric or polyhydric polyether polyols as the alcohol component affords polyester ether polyols which can likewise serve as starter compounds for preparation of the polyether carbonate polyols. Preference is given to using polyether polyols with Mₙ=150 to 2000 g/mol for preparation of the polyester ether polyols.

H-functional starter compounds that may be employed further include polycarbonate diols, in particular those having a molecular weight Mn in the range from 150 to 4500 g/mol, preferably 500 to 2500 g/mol, prepared, for example, by reaction of phosgene, dimethyl carbonate, diethyl carbonate or diphenyl carbonate with difunctional alcohols or polyester polyols or polyether polyols. Examples relating to polycarbonates may be found for example in EP-A 1359177. Polycarbonate diols that may be used include for example the Desmophen® C line from Covestro AG, for example Desmophen® C 1100 or Desmophen® C 2200.

In a further embodiment of the invention, polyether carbonate polyols, polycarbonate polyols and/or polyether ester carbonate polyols may be used as H-functional starter compounds. In particular, polyether carbonate polyols, polycarbonate polyols and/or polyether ester carbonate polyols may be obtained by reaction of alkylene oxides, preferably ethylene oxide, propylene oxide or mixtures thereof, optionally further comonomers, with CO2 in the presence of a further H-functional starter compound and using catalysts. These catalysts include double metal cyanide catalysts (DMC catalysts) and/or metal complex catalysts for example based on the metals zinc and/or cobalt, for example zinc glutarate catalysts (described for example in M. H. Chisholm et al., Macromolecules 2002, 35, 6494), so-called zinc diiminate catalysts (described for example in S. D. Allen, J. Am. Chem. Soc. 2002, 124, 14284) and so-called cobalt salen catalysts (described for example in U.S. Pat. No. 7,304,172 B2, US 2012/0165549 A1) and/or manganese salen complexes. An overview of known catalysts for the copolymerization of alkylene oxides and CO2 is provided for example by Chemical Communications 47 (2011) 141-163. The use of different catalyst systems, reaction conditions and/or reaction sequences results in the formation of random, alternating, block-type or gradient-type polyether carbonate polyols, polycarbonate polyols and/or polyether ester carbonate polyols. To this end, these polyether carbonate polyols, polycarbonate polyols and/or polyether ester carbonate polyols used as H-functional starter compounds may be prepared in a separate reaction step beforehand.

The H-functional starter compounds generally have an OH functionality (i.e., number of polymerization-active H atoms per molecule) of 1 to 8, preferably of 2 to 6, and more preferably of 2 to 4. The H-functional starter compounds are used either individually or as a mixture of at least two H-functional starter compounds.

Preferred H-functional starter compounds are alcohols having a composition according to general formula (II),

HO—(CH2)X—OH (II)

wherein x is a number from 1 to 20, preferably an even number from 2 to 20. Examples of alcohols according to formula (I) are ethylene glycol, 1,4-butanediol, 1,6-hexanediol, 1,8-octanediol, 1,10-decanediol and 1,12-dodecanediol. Further preferred H-functional starter compounds are neopentyl glycol, trimethylolpropane, glycerol, pentaerythritol, reaction products of the alcohols of formula (VII) with ε-caprolactone, for example reaction products of trimethylolpropane with ε-caprolactone, reaction products of glycerol with ε-caprolactone and reaction products of pentaerythritol with ε-caprolactone. Preferably employed H-functional starter compounds further include water, diethylene glycol, dipropylene glycol, castor oil, sorbitol and polyether polyols constructed from repeating polyalkylene oxide units.

It is particularly preferable when the H-functional starter compounds are at least one compound selected from the group consisting of ethylene glycol, propylene glycol, 1,3-propanediol, 1,3-butanediol, 1,4-butanediol, 1,5-pentanediol, 2-methylpropane-1,3-diol, neopentyl glycol, 1,6-hexanediol, diethylene glycol, dipropylene glycol, glycerol, trimethylolpropane, di- and trifunctional polyether polyols, wherein the polyether polyol is constructed from a di- or tri-H-functional starter compound and propylene oxide or a di- or tri-H-functional starter compound, propylene oxide and ethylene oxide. The polyether polyols preferably have an OH functionality of 2 to 4 and a molecular weight Mn in the range from 62 to 8000 g/mol, preferably a molecular weight and more preferably of ≥92 to ≤2000 g/mol.

A catalyst that may be used for preparing the polyether carbonate polyols according to the invention is, for example, a DMC catalyst (double metal cyanide catalyst). Other catalysts may also be employed alternatively or in addition. For the copolymerization of alkylene oxides and CO₂ zinc carboxylates or cobalt salen complexes for example may be employed alternatively or in addition. Suitable zinc carboxylates are for example zinc salts of carboxylic acids, in particular dicarboxylic acids, such as adipic acid or glutaric acid. An overview of known catalysts for the copolymerization of alkylene oxides and CO₂ is provided for example by Chemical Communications 47 (2011) 141-163.

The catalyst is preferably a DMC catalyst.

The double metal cyanide compounds present in the DMC catalysts preferentially employable in the process according to the invention are the reaction products of water-soluble metal salts and water-soluble metal cyanide salts.

Double metal cyanide (DMC) catalysts for use in the homopolymerization of alkylene oxides are known in principle from the prior art (see, for example, U.S. Pat. Nos. 3,404,109, 3,829,505, 3,941,849 and 5,158,922). DMC catalysts which are described in, for example, U.S. Pat. No. 5,470,813, EP-A 700 949, EP-A 743 093, EP-A 761 708, WO 97/40086, WO 98/16310 and WO 00/47649 possess a very high activity and allow for preparation of polyether carbonates at very low catalyst concentrations. A typical example is that of the highly active DMC catalysts described in EP-A 700 949 which contain not only a double metal cyanide compound (e.g. zinc hexacyanocobaltate(III)) and an organic complex ligand (e.g. tert-butanol) but also a polyether having a number-average molecular weight greater than 500 g/mol.

The DMC catalysts which can be used in accordance with the invention are preferably obtained by
(1) reacting an aqueous solution of a metal salt with the aqueous solution of a metal cyanide salt in the presence of one or more organic complex ligands, for example an ether or alcohol, in a first step
(2) removing the solid from the suspension obtained from (a) by known techniques (such as centrifugation or filtration) in a second step,
(3) optionally washing the isolated solid with an aqueous solution of an organic complex ligand (for example by resuspending and subsequent reisolation by filtration or centrifugation) in a third step,
(4) and subsequently drying the obtained solid at temperatures of in general 20-120° C. and at pressures of in general 0.1 mbar to atmospheric pressure (1013 mbar), optionally after pulverizing,
   wherein in the first step or immediately after the precipitation of the double metal cyanide compound (second step) one or more organic complex ligands, preferably in excess (based on the double metal cyanide compound), and optionally further complex-forming components are added.

The double metal cyanide compounds present in the DMC catalysts employable in accordance with the invention are the reaction products of water-soluble metal salts and water-soluble metal cyanide salts.

By way of example, an aqueous zinc chloride solution (preferably in excess relative to the metal cyanide salt) and potassium hexacyanocobaltate are mixed and then dimethoxyethane (glyme) or tert-butanol (preferably in excess, relative to zinc hexacyanocobaltate) is added to the resulting suspension.

Metal salts suitable for preparing the double metal cyanide compounds preferably have a composition according to general formula (III),

M(X)ₙ (III),

wherein
M is selected from the metal cations Zn²⁺, Fe²⁺, Ni²⁺, Mn²⁺, Co²⁺, Sr²⁺, Sn²⁺, Pb²⁺ and Cu²⁺, is preferably Zn²⁺, Fe²⁺, Co²⁺ or Ni²⁺,
X are one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;
n is 1 when X=sulfate, carbonate or oxalate and
n is 2 when X=halide, hydroxide, carboxylate, cyanate, thiocyanate, isocyanate, isothiocyanate or nitrate,
or suitable metal salts preferably have a composition according to general formula (IV),

Mᵣ(X)₃ (IV),

wherein
M is selected from the metal cations Fe³⁺, Al³⁺, Co³⁺ and Cr³⁺,
X comprehends one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;
r is 2 when X=sulfate, carbonate or oxalate, and
r is 1 when X=halide, hydroxide, carboxylate, cyanate, thiocyanate, isocyanate, isothiocyanate or nitrate,
or suitable metal salts preferably have a composition according to general formula (V),

M(X)ₛ (V),

wherein
M is selected from the metal cations Mo⁴⁺, V⁴⁺ and W⁴⁺,
X comprehends one or more (i.e. different) anions, preferably an anion selected from the group consisting of the halides (i.e. fluoride, chloride, bromide, iodide), hydroxide, sulfate, carbonate, cyanate, thiocyanate, isocyanate, isothiocyanate, carboxylate, oxalate and nitrate;
s is 2 when X=sulfate, carbonate or oxalate, and
s is 4 when X=halide, hydroxide, carboxylate, cyanate, thiocyanate, isocyanate, isothiocyanate or nitrate,
or suitable metal salts preferably have a composition according to general formula (VI),

M(X)ₜ (VI),

wherein
M is selected from the metal cations Mo⁶⁺ and W⁶⁺,
X comprehends one or more (i.e. different) anions, preferably anions selected from the group of the halides (i.e. fluoride, chloride, bromide, iodide), hydroxide, sulfate, carbonate, cyanate, thiocyanate, isocyanate, isothiocyanate, carboxylate, oxalate and nitrate;
t is 3 when X=sulfate, carbonate or oxalate, and
t is 6 when X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. Mixtures of different metal salts may also be employed.

Metal cyanide salts suitable for preparing the double metal cyanide compounds preferably have a composition according to general formula (VII)

(Y)ₐM′(CN)_{b}(A)_{c} (VII),

wherein
M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II), Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sr²⁺, Ba²⁺), A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate and a, b and c are integers, wherein the values for a, b and c are selected such as to ensure the electroneutrality of the metal cyanide salt, a is preferably 1, 2, 3 or 4; b is preferably 4, 5 or 6; c preferably has the value 0.

Examples of suitable metal cyanide salts are sodium hexacyanocobaltate(III), potassium hexa-cyanocobaltate(III), potassium hexacyanoferrate(II), potassium hexacyanoferrate(III), calcium-hexacyanocobaltate(III) and lithium hexacyanocobaltate(III).

Preferred double metal cyanide compounds present in the DMC catalysts employable in accordance with the invention are compounds having compositions according to general formula (VIII)

Mₓ[M′ₓ.(CN)_{y}]_{z} (VIII),

Where M is as defined in formulae (I) to (IV) and
M′ is as defined in formula (V) and
x, x′, y and z are integers selected such as to ensure electroneutrality of the double metal cyanide compound.

It is preferable when

x=3, x′=1, y=6 and z=2,

### M=Zn(II), Fe(II), Co(II) or Ni(II) and

### M′=Co(III), Fe(III), Cr(III) or Ir(III).

Examples of suitable double metal cyanide compounds a) are zinc hexacyanocobaltate(III), zinc hexacyanoiridate(III), zinc hexacyanoferrate(III) and cobalt(II) hexacyanocobaltate(III). Further examples of suitable double metal cyanide compounds may be found, for example, in U.S. Pat. No. 5,158,922 (column 8 lines 29-66). Zinc hexacyanocobaltate(III) may be used with particular preference.

The organic complex ligands which may be added in the preparation of the DMC catalysts are disclosed in, for example, U.S. Pat. No. 5,158,922 (see, in particular, column 6, lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). The organic complex ligands employed are, for example, water-soluble organic compounds having heteroatoms, such as oxygen, nitrogen, phosphorus or sulfur, capable of forming complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-Butyn-2-ol), compounds comprising both aliphatic or cycloaliphatic ether groups and aliphatic hydroxyl groups (such as ethylene glycol mono-tert-butyl ether, diethylene glycol mono-tert-butyl ether, tripropylene glycol monomethyl ether and 3-methyl-3-oxetanemethanol for example). The most preferred organic complex ligands are selected from at least one compound of the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol.

Optionally employed in the preparation of the DMC catalysts employable in accordance with the invention are one or more complex-forming component(s) selected from polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkylacrylates, polyalkylmethacrylates, polyvinyl methyl ethers, polyvinyl ethyl ethers, polyvinyl acetate, polyvinyl alcohol, poly-N-vinylpyrrolidone, poly(N-vinylpyrrolidone-co-acrylic acid), polyvinyl methyl ketone, poly(-vinylphenol), poly(acrylic acid-co-styrene), oxazoline polymers, polyalkyleneimines, maleic acid and maleic anhydride copolymers, hydroxyethyl cellulose and polyacetals, or of the glycidyl ethers, glycosides, carboxylic esters of polyhydric alcohols, gallic acids or the salts, esters or amides thereof, cyclodextrins, phosphorus compounds, α,β-unsaturated carboxylic esters or ionic surface- or interface-active compounds.

In the preparation of the DMC catalysts employable in accordance with the invention preference is given to using the aqueous solutions of the metal salt (e.g. zinc chloride) in a stoichiometric excess (at least 50 mol %) relative to the metal cyanide salt in the first step. This corresponds to a molar ratio of metal salt to metal cyanide salt of at least 2.25:1.00. The metal cyanide salt (e.g. potassium hexacyanocobaltate) is reacted in the presence of the organic complex ligand (e.g. tert-butanol) to form a suspension comprising the double metal cyanide compound (e.g. zinc hexacyanocobaltate), water, excess metal salt and the organic complex ligand.

The organic complex ligand may be present in the aqueous solution of the metal salt and/or the metal cyanide salt, or it is added directly to the suspension obtained after precipitation of the double metal cyanide compound. It has proven advantageous to mix the aqueous solutions of the metal salt and of the metal cyanide salt, and the organic complex ligand, with vigorous stirring. The suspension formed in the first step is then optionally treated with a further complex-forming component. The complex-forming component is preferably used in a mixture with water and organic complex ligand. A preferred process for performing the first step (i.e. the preparation of the suspension) is effected using a mixing nozzle, more preferably using a jet disperser, as described, for example, in WO-A 01/39883.

In the second step, the solid (i.e. the precursor of the catalyst) can be isolated from the suspension by known techniques, such as centrifugation or filtration.

In a preferred variant, the isolated solids are then washed with an aqueous solution of the organic complex ligand in a third process step (for example by resuspension and subsequent reisolation by filtration or centrifugation). Water-soluble byproducts for example, such as potassium chloride, may be removed from the catalyst employable in accordance with the invention in this way. The amount of the organic complex ligand in the aqueous washing solution is preferably between 40 and 80 wt % based on the overall solution.

Optionally in the third step the aqueous washing solution is admixed with a further complex-forming component, preferably in a range between 0.5 and 5 wt % based on the overall solution.

It is also advantageous to wash the isolated solids more than once. It is preferable when a first washing step (3.-1) comprises washing with an aqueous solution of the unsaturated alcohol (for example by resuspension and subsequent reisolation by filtration or centrifugation), in order thereby to remove, for example, water-soluble byproducts, such as potassium chloride, from the catalyst employable in accordance with the invention. The amount of the unsaturated alcohol in the aqueous washing solution is particularly preferably between 40 and 80 wt % based on the overall solution of the first washing step. In the further washing steps (3.-2), either the first washing step is repeated one or more times, preferably from one to three times, or, preferably, a nonaqueous solution, for example a mixture or solution of unsaturated alcohol and further complex-forming component (preferably in the range between 0.5 and 5 wt %, based on the total amount of the washing solution of step (3.-2)), is employed as the washing solution, and the solid is washed therewith one or more times, preferably one to three times.

The isolated and optionally washed solid may subsequently be dried at temperatures of 20-100° C. and at pressures of 0.1 mbar to atmospheric pressure (1013 mbar), optionally after pulverizing.

A preferred process for isolating the DMC catalysts employable in accordance with the invention from the suspension by filtration, filtercake washing and drying is described in WO-A 01/80994.

Embodiments of the process and further aspects of the invention are described hereinbelow. They may be combined with one another as desired unless the opposite is clear from the context.

In one embodiment of the process according to the invention the at least one alkylene oxide is selected from the group consisting of ethylene oxide, propylene oxide and styrene oxide.

In a further embodiment of the process according to the invention the at least one H-functional starter compound is selected from the group of polyether polyols, polyester polyols, polyether ester polyols, polyether carbonate polyols, polycarbonate polyols and polyacrylate polyols, preferably polyether polyols and polyether carbonate polyols.

In a further embodiment of the process according to the invention the molar ratio of the at least one employed alkylene oxide to the employed carbon disulfide is in a range from ≥1:1 to ≤100:1, bevorzugt from ≥1:1 to ≤50:1 and particularly preferably from ≥1:1 to ≤20:1.

In a further embodiment of the process according to the invention

(α) a reactor is initially charged with the double metal cyanide catalyst and at least one H-functional starter compound and an inert gas is passed through the reactor at a temperature of 50° C. to 200° C. and simultaneously by removing the inert gas a reduced (absolute) pressure of 10 mbara to 800 mbara in the reactor is established;
(β) the mixture from step (α) is admixed with a portion (based on the entirety of the amount of alkylene oxides employed in steps (β) and (γ)) of the at least one alkylene oxide at temperatures of 50° C. to 200° C.;
(γ) carbon disulfide and at least one alkylene oxide are added to the mixture resulting from step (β) (“copolymerisation”). The alkylene oxides used for the copolymerization may be identical or different to the alkylene oxides used in step (β).

In a preferred variant the amount of the at least one alkylene oxide employed in the activation in step (β) is 0.1 to 35.0 wt %, preferably 1.0 to 30.0 wt %, particularly preferably 2.0 to 25.0 wt % (based on the amount of starter compound employed in step (α)). The alkylene oxide may be added in one step or in a stepwise addition in two or more more portions. The DMC catalyst is preferably employed in an amount such that the content of DMC catalyst in the resulting polyether thiocarbonate polyol is 10 to 10 000 ppm, particularly preferably 20 to 5000 ppm and most preferably 50 to 500 ppm.

Step (α):

The addition of the individual components may be effected simultaneously or consecutively in any desired sequence; it is preferable when DMC catalyst is initially charged first and H-functional starter compound is added simultaneously or subsequently.

The DMC catalyst may be added in solid form or as a suspension in an H-functional starter compound. If the DMC catalyst is added as a suspension, said suspension is preferably added to the one or more H-functional starter compound.

Step (β):

The establishment of an atmosphere of inert gas and the metered addition of the at least one alkylene oxide may in principle be effected in different ways. The admission pressure is preferably established by introduction of inert gas, wherein the (absolute) pressure is 10 mbara to 100 bara, preferably 100 mbara to 50 bara and by preference 500 mbara to 50 bara. The commencement of the metered addition of the alkylene oxide may be effected from vacuum or at a previously selected admission pressure. The total (absolute) pressure established in step (β) of the atmosphere of inert gas and optionally alkylene oxide is preferably a range from 10 mbara to 100 bara, preferably 100 mbara to 50 bara, and by preference 500 mbara to 50 bara. The pressure is optionally readjusted during or after the metered addition of the alkylene oxide by introducing further inert gas, wherein the (absolute) pressure is 10 mbara to 100 bara, preferably 100 mbara to 50 bara and by preference 500 mbara to 50 bara.

Step (γ):

The metered addition of carbon disulfide and of the at least one alkylene oxide may be effected simultaneously, alternately or sequentially. It also is possible to increase or reduce the pressure in the reactor gradually or stepwise or to leave it constant during addition of carbon disulfide and of the alkylene oxide. It is preferable when the total pressure is kept constant during the reaction by replenishment of inert gas. The metered addition of carbon disulfide and of the at least one alkylene oxide is effected simultaneously, alternately or sequentially. It is possible to effect metered addition of the carbon disulfide and alkylene oxide at a constant metering rate or to increase or reduce the metering rate gradually or stepwise or to add the carbon disulfide and alkylene oxide in portions. The carbon disulfide and alkylene oxide is preferably added to the reaction mixture at a constant metering rate. If two or more alkylene oxides are employed for synthesis of the polyether thiocarbonate polyols, the alkylene oxides may be metered in individually or as a mixture. The metered addition of the alkylene oxides can be effected simultaneously, alternately or sequentially, each via separate metering points (addition points), or via one or more metering points and the alkylene oxides may be metered in individually or as a mixture. It is possible via the manner and/or sequence of the metered addition of the alkylene oxides and/or of the carbon dioxide to synthesize random, alternating, block-type or gradient-type polyether thiocarbonate polyols.

In a preferred embodiment it has further been found for the process according to the invention that the copolymerization (step (γ)) for preparing the polyether thiocarbonate polyols is performed at 50° C. to 150° C., preferably at 60° C. to 145° C., particularly preferably at 70° C. to 140° C. and very particularly preferably at 90° C. to 130° C. Below 50° C. the reaction proceeds only very slowly. At temperatures above 150° C. the amount of unwanted by-products rises severely.

It is preferable in the embodiment hereinabove when in step (γ) carbon disulfide and the at least one alkylene oxide are continuously metered into the mixture resulting from step (β).

In a further embodiment of the process according to the invention

(α′) a reactor is initially charged with the double metal cyanide catalyst and the at least H-functional starter compound and/or a suspension medium which does not comprise H-functional groups and an inert gas is passed through the reactor at a temperature of 50° C. to 200° C. and simultaneously by removing the inert gas a reduced (absolute) pressure of 10 mbara to 800 mbara in the reactor is established;
(β′) the mixture from step (α′) is admixed with a portion (based on the entirety of the amount of alkylene oxides employed in steps (β′) and (γ′)) of the at least one alkylene oxide at temperatures of 50° C. to 200° C. and subsequently the addition of the at least one alkylene oxide is interrupted;
(γ′) at least one alkylene oxide, carbon disulfide and at least one H-functional starter compound and optionally also double metal cyanide catalyst is continuously metered into the reactor during the reaction.

It is preferable in the embodiment hereinabove when in step (α′) a reactor is initially charged with the double metal cyanide catalyst, at least one suspension medium which does not comprise H-functional groups and an inert gas is passed through the reactor at a temperature of 50° C. to 200° C. and simultaneously by removing the inert gas a reduced (absolute) pressure in the reactor of 10 mbara to 800 mbara is established.

It is further preferable when in step (γ′) the metered addition of the at least one H-functional starter compound is terminated before the addition of the at least one alkylene oxide.

In a preferred embodiment it has further been found for the process according to the invention that the copolymerization (step (γ′)) for preparing the polyether thiocarbonate polyols is performed at 50° C. to 150° C., preferably at 60° C. to 145° C., particularly preferably at 70° C. to 140° C. and very particularly preferably at 90° C. to 130° C. Below 50° C. the reaction proceeds only very slowly. At temperatures above 150° C. the amount of unwanted by-products rises severely.

When performing the process α′/β′/β′1/β′2/γ in semi-batchwise operation, the amount of the H-functional starter compounds metered into the reactor continuously during the reaction is preferably at least 20 mol % equivalents, particularly preferably 70 to 95 mol % equivalents (in each case based on the total amount of H-functional starter compounds). When performing the process continuously, the amount of the H-functional starter compounds metered into the reactor continuously during the reaction is preferably at least 80 mol % equivalents, particularly preferably 95 to 105 mol % equivalents (in each case based on the total amount of H-functional starter compounds).

In a further embodiment of the process according to the invention it is provided that at least steps (γ) or (γ′) are additionally performed in the presence of carbon dioxide. Preference is given to using an excess of carbon dioxide based on the calculated amount of incorporated carbon dioxide in the polyether carbonate polyol, since an excess of carbon dioxide is advantageous due to the inertness of carbon dioxide. The amount of carbon dioxide may be specified via the total pressure under the particular reaction conditions. A total (absolute) pressure that has proved advantageous for the copolymerization for preparing the polyether thiocarbonate polyols is the range from 0.01 to 120 bara, preferably 0.1 to 110 bara, particularly preferably from 1 to 100 bara. It is possible to feed in the carbon dioxide continuously or discontinuously. This depends on how quickly the alkylene oxides and the CO₂ are consumed and on whether the product is to include any CO₂-free polyether blocks or blocks having a different CO₂ content. The amount of the carbon dioxide (reported as pressure) may likewise vary during addition of the alkylene oxides. Depending on the reaction conditions chosen the CO₂ may be introduced into the reactor in the gaseous, liquid or supercritical state. CO₂ may also be added to the reactor as a solid and then converted to the gaseous, dissolved, liquid and/or supercritical state under the chosen reaction conditions.

In steps (β) and/or (γ) the carbon dioxide is preferably introduced into the mixture by
(i) sparging the reaction mixture in the reactor from below (for example via an inlet tube or a sparging ring (distributor ring) with passage of the gas below the stirrer blade) and depending on the gas loading optionally in combination with a gas distribution stirrer (for example a disc stirrer, paddle stirrer, Rushton turbine (for example Lightnin R-100®, Ekato PHASE-JET®, Smith Turbine® from Philadelphia Mixing Solutions, Chemineer BT-6® or CD-6® stirrer blade), further stirrer means (of any desired type, e.g. depending on the slenderness ratio of the reactor axially conveying turbines, stirring means which support heat transfer to internal cooling surfaces and/or promote mass transfer via the liquid surface) optionally being arranged on the stirrer shaft; a combination of two or more stirring means has the technical advantage that the mass transfer of the gas into the liquid phase at the surface of the reaction mixture can be improved;
(ii) using a hollow shaft stirrer (i.e. using the principle of an ejector), for example as a tube stirrer, pitched-blade turbine having hollow blades, Ekato GASJET®, PREMEX “br” series laboratory sparging stirrer, laboratory sparging stirrer from Parr Instruments; the effect of using a hollow shaft stirrer is that the gas phase accumulating in the gas space is aspirated through a hollow shaft and reintroduced into the reaction mixture from below;
(iii) combination of the metered additions according to (i) and (ii) which is advantageous for operation at a constant fill level in the reactor, for example the combination of the metered additions according to (i) and (ii) may be effected such that a sparging of the reaction mixture in the reactor from below as per any of the options recited under (i) is combined with a hollow-shaft stirrer according to (ii) (for example a gas distribution stirrer having an ejector as a second dispersion stage arranged thereabove), preferably in such a way that the introduction of the gas from below is effected below the hollow-shaft stirrer; and/or
(iv) sparging via the liquid surface by using appropriate typically multi-stage stirring means (e.g. MIG or Ekato MIG/INTERMIG®) or using stirring means effective at the liquid surface (e.g. grid stirrers).

The hollow-shaft stirrer is preferably a stirrer where the gas is introduced into the reaction mixture via a hollow shaft in the stirrer. The rotation of the stirrer in the reaction mixture (i.e. in the course of mixing) gives rise to a negative pressure at the end of the stirrer paddle connected to the hollow shaft, such that the gas phase (containing CO₂ and any unconsumed alkylene oxide) is sucked out of the gas space above the reaction mixture and is passed through the hollow shaft of the stirrer into the reaction mixture.

The sparging of the reaction mixture as per (i), (ii), (iii) or (iv) can be effected with freshly metered-in carbon dioxide in each case (and/or may be combined with a suctioning-off of the gas out of the gas space above the reaction mixture and subsequent recompression of the gas. For example, the gas sucked out of the gas space above the reaction mixture and compressed, optionally mixed with fresh carbon dioxide and/or alkylene oxide, is introduced into the reaction mixture as per (i), (ii), (iii) and/or (iv). Preferably, the pressure drop which arises through incorporation of the carbon dioxide and the alkylene oxide into the reaction product during the coppolymerization is compensated with freshly metered-in carbon dioxide.

The introduction of the alkylene oxide may be effected separately or together with the CO₂, either via the liquid surface or directly into the liquid phase. Preferably, the alkylene oxide is introduced directly into the liquid phase, since this has the advantage that rapid mixing of the introduced alkylene oxide with the liquid phase is effected and local concentration peaks of alkylene oxide are thus avoided. The introduction into the liquid phase may be effected via one or more inlet tubes, one or more nozzles or one or more annular arrangements of multimetering points which are preferably arranged at the bottom of the reactor and/or at the side wall of the reactor.

The configuration of the stirring conditions are to be undertaken on a case-by-case basis by those skilled in the art depending on the reaction conditions (e.g. liquid phase viscosity, gas loading, surface tension) and according to the state of the art of stirring in order to safely avoid for example flooding of a stirring means sparged from below or to ensure the desired power input and/or mass transfer in the sparging state. The reactor optionally comprises internals such as, for example, baffles and/or cooling surfaces (configured as a tube, coil, plates or in a similar shape), sparging ring and/or inlet tube. Further heat exchanger surfaces may be arranged in a pumped circulation circuit wherein the reaction mixture is then conveyed via suitable pumps (e.g. screw-spindle pumps, centrifugal pumps or gear pumps). The circuit stream may for example also be recycled into the reactor via an injector nozzle to aspirate a portion of the gas space and intensively mix it with the liquid phase to improve mass transfer.

The sparging of the reaction mixture in the reactor as per (i) is preferably effected by means of a sparging ring, a sparging nozzle, or by means of a gas inlet tube. The sparging ring is preferably an annular arrangement or two or more annular arrangements of sparging nozzles, preferably arranged at the bottom of the reactor and/or on the side wall of the reactor.

Steps α/α′, β/β′ and γ/γ′ may be performed in the same reactor or may each be performed separately in different reactors. Particularly preferred reactor types are stirred tanks, tubular reactors, and loop reactors. If the reaction steps α/α′, β/β′ and γ/γ′ are performed in different reactors a different reactor type may be used for each step.

Polyether thiocarbonate polyols may be prepared in a stirred tank, the stirred tank being cooled via the reactor jacket, internal cooling surfaces and/or cooling surfaces within a pumped circulation circuit, depending on the embodiment and mode of operation. Both in semi-batchwise application, where the product is withdrawn only once the reaction has ended, and in continuous application, where the product is withdrawn continuously, particular attention should be paid to the metering rate of the alkylene oxide. It should be adjusted such that the alkylene oxides react sufficiently rapidly despite the inhibiting effect of the carbon dioxide. The concentration of free alkylene oxides in the reaction mixture during the activation step (step β/(β′) is preferably >0% to 100 wt %, particularly preferably >0 to 50 wt %, most preferably >0 to 20 wt % (in each case based on the weight of the reaction mixture). The concentration of free alkylene oxides in the reaction mixture during the reaction (step γ/γ′) is preferably >0% to 40 wt %, particularly preferably >0 to 25 wt %, most preferably >0 to 15 wt % (in each case based on the weight of the reaction mixture).

When running the reaction in a tubular reactor the catalyst-starter mixture dried as per step α/α′ or the catalyst-starter mixture activated as per steps α/α′ and β/β′ and optionally further starters and also alkylene oxides and carbon dioxide are pumped continuously through a tube. When using a catalyst-starter mixture dried as per step α/α′ the activation as per step β/β′ takes place in the first part of the tubular reactor, and the copolymerization as per step β/β′ takes place in the second part of the tubular reactor. The molar ratios of the co-reactants vary according to the desired polymer. In a preferred embodiment carbon dioxide is metered in in its liquid or supercritical form to achieve optimal miscibility of the components. The carbon dioxide can be introduced into the reactor at the entrance to the reactor and/or via metering points arranged along the reactor. A portion of the epoxide may be introduced at the entrance to the reactor. The remaining amount of the epoxides is preferably introduced into the reactor via a plurality of metering points arranged along the reactor. It is advantageous to install mixing elements for better mixing of the co-reactants as are marketed for example by Ehrfeld Mikrotechnik BTS GmbH or mixer-heat exchanger elements which simultaneously improve mixing and heat removal.

It is likewise possible to employ loop reactors for preparation of polyether thiocarbonate polyols. These generally include reactors having internal and/or external recycling (optionally with heat exchange surfaces arranged in the circuit), for example a jet loop reactor or Venturi loop reactor, which may also be operated continuously, or a tubular reactor configured in the shape of a loop having suitable apparatuses for circulation of the reaction mixture or a loop of two or more serially connected tubular reactors or two or more serially connected stirred tanks.

To achieve full conversion, the reaction apparatus in which step γ/γ′ is performed often has a further tank or a tube (“delay tube”) connected downstream of it in which residual concentrations of free alkylene oxides present after the reaction undergo reaction. This downstream reactor is preferably at the same pressure as the reaction apparatus in which reaction step γ/γ′ is performed. However, the pressure in the downstream reactor may also be higher or lower. In a further preferred embodiment optionally co-used carbon dioxide is fully or partly discharged after reaction step (γ/γ′) and the downstream reactor operated at atmospheric pressure or slightly positive pressure. The temperature in the downstream reactor is preferably 10° C. to 150° C. and preferably 20° C. to 100° C. The reaction mixture preferably comprises less than 0.05 wt % of alkylene oxide at the end of the downstream reactor.

The present invention likewise relates to a polyether thiocarbonate polyol obtainable by a process according to the invention, wherein the total content of the functional group:

—S—C(═O)—

in the polymer is ≤21 mol %.

The appearance of this functional group is regarded as an indication of atom exchange during the polymerization. Very little, if any, thereof appears in the polymer formed by the process according to the invention. Detection of this functional group is via the intense carbonyl bands in the IR spectrum.

The polyether thiocarbonate polyols obtainable by the process according to the invention have a very high refractive index, are crosslinkable and may be employed for example for preparing coatings, foams, sealing materials, thermoplastics, thermosets and rubbers. The polyether thiocarbonate polyols are readily processable, in particular by reaction with di- and/or polyisocyanates to afford polyurethanes. For polyurethane applications, it is preferable to employ polyether thiocarbonate polyols based on an H-functional starter compound having a functionality of at least 2. The polyether thiocarbonate polyols obtainable by the process according to the invention may further be used in applications such as washing and cleaning compositions or cosmetic formulations.

The polyether thiocarbonate polyols obtained in accordance with the invention preferably have an OH functionality (i.e. average number of OH groups per molecule) which from the of at least 0.8, preferably of 1 to 8, particularly preferably of 1 to 6 and very particularly preferably of 2 to 4. The molecular weight Mn of the obtained polyether thiocarbonate polyols is preferably at least 400, more preferably 400 to 1 000 000 g/mol and most preferably 500 to 60 000 g/mol.

The polyether thiocarbonate polyol according to the invention preferably has a refractive index no (20° C.) of ≥1.45.

The present invention further provides a polyurethane polymer obtainable from the reaction of a polyol component A comprising an inventive polyether thiocarbonate polyol A1 with at least one polyisocyanate component B.

Employed as polyisocyanate component B are aliphatic, cycloaliphatic, araliphatic, aromatic and heterocyclic polyisocyanates, such as are described for example by W. Siefken in Justus Liebigs Annalen der Chemie, 562, pages 75 to 136, for example those of formula (IX)

Q(NCO)n (IX)

in which
n=2-4, preferably 2-3,
and
Q is an aliphatic hydrocarbon radical having 2-18, preferably 6-10, carbon atoms, a cycloaliphatic hydrocarbon radical having 4-15, preferably 6-13, carbon atoms or an araliphatic hydrocarbon radical having 8-15, preferably 8-13, carbon atoms.

Suitable polyisocyanate components B are the aromatic, araliphatic, aliphatic or cycloaliphatic polyisocyanates known per se to those skilled in the art which may also comprise iminooxadiazinedione, isocyanurate, uretdione, urethane, allophanate, biuret, urea, oxadiazinetrione, oxazolidinone, acylurea, carbamate and/or carbodiimide structures. These may be employed individually or in any desired mixtures with one another in B.

The abovementioned polyisocyanate components B are thus based on diisocyanates or triisocyanates or higher-functional isocyanates known per se to those skilled in the art having aliphatically, cycloaliphatically, araliphatically and/or aromatically bonded isocyanate groups, it being immaterial whether these were produced using phosgene or by phosgene-free processes. Examples of such diisocyanates or triisocyanates or higher-functional isocyanates are 1,4-diisocyanatobutane, 1,5-diisocyanatopentane, 1,6-diisocyanatohexane (HDI), 2-methyl-1,5-diisocyanatopentane, 1,5-diisocyanato-2,2-dimethylpentane, 2,2,4-/2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane (Desmodur® W, Covestro AG, Leverkusen, Del.), 4-isocyanatomethyl-1,8-octanediisocyanate (triisocyanatononane, TIN), ω,ω″-′-diisocyanato-1,3-dimethylcyclohexane (H6XDI), 1-isocyanato-1-methyl-3-isocyanatomethylcyclohexane, 1-isocyanato-1-methyl-4-isocyanatomethylcyclohexane, bis(isocyanatomethyl)norbornane, 1,5-naphthalene diisocyanate, 1,3- and 1,4-bis(2-isocyanato-prop-2-yl)benzene (TMXDI), 2,4- and 2,6-diisocyanatotoluene (TDI), in particular the 2,4 and the 2,6-isomers and industrial mixtures of the two isomers, 2,4′- and 4,4′-diisocyanatodiphenylmethane (MDI), 1,5-diisocyanatonaphthalene, 1,3-bis(isocyanatomethyl)benzene (XDI) and any desired mixtures of the recited compounds and also polyfunctional isocyanates obtained by dimerization or trimerization or higher oligomerization of the aforementioned isocyanates and comprising isocyanurate rings, iminooxadiazinedione rings, uretdione rings, urethonimine rings and also polyfunctional isocyanates obtained by adduct formation of the recited isocyanates onto mixtures of different polyhydric alcohols, such as TMP, TME or pentaerythritol.

In a preferred embodiment of the invention the polyurethane polymer is a polyurethane foam such as a rigid polyurethane foam or flexible polyurethane foam for example.

The preparation of the isocyanate-based foams is known per se and described for example in DE-A 1 694 142, DE-A 1 694 215 and DE-A 1 720 768 and also in Kunststoff-Handbuch volume VII, Polyurethanes, edited by Vieweg and Höchtlein, Carl Hanser Verlag, Munich 1966, and in the new edition of this book, edited by G. Oertel, Carl Hanser Verlag Munich, Vienna 1993.

The present invention provides a process for preparing polyurethane foams by reaction of

A1 at least one polyether thiocarbonate polyol according to the invention,
A2 at least one compound having isocyanate-reactive hydrogen atoms and having a molecular weight of 400-15.000,
and/or
A3 at least one compound optionally having isocyanate-reactive hydrogen atoms and having a molecular weight of 62-399,
A4 water and/or physical blowing agents,
A5 optionally auxiliary and additive substances such as
a) catalysts,
b) surface-active additive substances,
c) pigments or flame retardants,
with at least one
B polyisocyanate component.

Component A2 are compounds having at least two isocyanate-reactive hydrogen atoms and having a molecular weight, in general, of 400-15.000 g/mol. This is to be understood as meaning not only amino-containing but also thiol-containing or carboxyl-containing compounds, preferably hydroxyl-containing compounds, in particular compounds having 2 to 8 hydroxyl groups, specifically those having a molecular weight of 1000 to 6000 g/mol, preferably 2000 to 6000 g/mol, for example polyethers and polyesters and also polycarbonates and polyesteramides having at least 2, generally 2 to 8, but preferably 2 to 6, hydroxyl groups as are known per se for the preparation of homogeneous and cellular polyurethanes and as described for example in EP-A 0 007 502, pages 8-15. Polyethers containing at least two hydroxyl groups are preferred in accordance with the invention.

Component A3 are compounds having at least two isocyanate-reactive hydrogen atoms and a molecular weight of 32 to 399. This is to be understood as meaning hydroxyl-containing and/or amino-containing and/or thiol-containing and/or carboxyl-containing compounds, preferably hydroxyl-containing and/or amino-containing compounds, which serve as chain extenders or crosslinkers. These compounds generally have 2 to 8, preferably 2 to 4, isocyanate-reactive hydrogen atoms. Employable as component A2 are for example ethanolamine, diethanolamine, triethanolamine, sorbitol and/or glycerol. Further examples of compounds of component A2 are described in EP-A 0 007 502, pages 16-17.

Water and/or physical blowing agents are employed as component A4. Physical blowing agents employed as blowing agents are for example carbon dioxide and/or volatile organic substances.

Optionally used as component A5 are auxiliary and additive substances such as

a) catalysts (activators),
b) surface-active additive substances, such as emulsifiers and foam stabilizers, in particular those having low emissions, for example products of the Tegostab® LF series,
c) additives such as reaction retardants (for example acidic substances such as hydrochloric acid or organic acyl halides), cell regulators (for example paraffins or fatty alcohols or dimethylpolysiloxanes), pigments, dyes, flame retardants (for example tricresyl phosphate), stabilizers against aging and weathering effects, plasticizers, fungistatic and bacteriostatic substances, fillers (for example barium sulfate, kieselguhr, carbon black or whiting) and release agents.

These auxiliary and additive substances for optional co-use are described for example in EP-A 0 000 389, pages 18-21. Further examples of auxiliary and additive substances for optional co-use according to the invention and also particulars concerning ways these auxiliary and additive substances are used and function are described in Kunststoff-Handbuch, volume VII, edited by G. Oertel, Carl-Hanser-Verlag, Munich, 3rd edition, 1993, for example on pages 104-127.

Preferred catalysts are aliphatic tertiary amines (for example trimethylamine, tetramethylbutanediamine), cycloaliphatic tertiary amines (for example 1,4-diaza[2.2.2]bicyclooctane, aliphatic amino ethers (for example dimethylaminoethyl ether and N,N,N-trimethyl-N-hydroxyethylbisaminoethyl ether), cycloaliphatic amino ethers (for example N-ethylmorpholine), aliphatic amidines, cycloaliphatic amidines, urea, derivatives of urea (for example aminoalkylureas; see, for example, EP-A 0 176 013, especially (3-dimethylaminopropylamino)urea), and tin catalysts (for example dibutyltin oxide, dibutyltin dilaurate, tin octoate).

Particularly preferred catalysts are

urea, derivatives of urea and/or
amines and amino ethers, each of which contains a functional group which undergoes chemical reaction with the isocyanate. The functional group is preferably a hydroxyl group, a primary or secondary amino group. These particularly preferred catalysts have the advantage that they exhibit strongly reduced migration and emission characteristics.

Examples of particularly preferred catalysts include: (3-dimethylaminopropylamine)urea, 2-(2-dimethylaminoethoxy)ethanol, N,N-bis(3-dimethylaminopropyl)-N-isopropanolamine, N,N,N-trimethyl-N-hydroxyethylbisaminoethyl ether and 3-dimethylaminopropylamine.

In a first embodiment the invention relates to processes for preparing polyether thiocarbonate polyols comprising the step of reacting carbon disulfide and at least one alkylene oxide in the presence of a double metal cyanide catalyst and at least one H-functional starter compound, characterized in that before first contact with carbon disulfide the double metal cyanide catalyst has previously been contacted with at least one alkylene oxide.

In a second embodiment the invention relates to a process according to the first embodiment, wherein the at least one alkylene oxide is selected from the group consisting of ethylene oxide, propylene oxide and styrene oxide.

In a third embodiment the invention relates to a process according to either of the first and second embodiments, wherein the at least one H-functional starter compound is selected from the group of polyether polyols, polyester polyols, polyether ester polyols, polyether carbonate polyols, polycarbonate polyols and polyacrylate polyols.

In a fourth embodiment the invention relates to a process according to any of the first to third embodiments, wherein the molar ratio of the at least one employed alkylene oxide to the employed carbon disulfide is in a range from ≥1:1 to ≤100:1, preferably from ≥1:1 to ≤50:1 and particularly preferably from ≥1:1 to ≤20:1.

In a fifth embodiment the invention relates to a process according to any of the first to fourth embodiments, wherein

(α) a reactor is initially charged with the double metal cyanide catalyst and the at least one H-functional starter compounds and an inert gas is passed through the reactor at a temperature of 50° C. to 200° C. and simultaneously by removing the inert gas a reduced (absolute) pressure in the reactor of 10 mbara to 800 mbara is established;
(β) the mixture from step (α) is admixed with a portion (based on the entirety of the amount of alkylene oxides employed in steps (β) and (γ)) of the at least one alkylene oxide at temperatures of 50° C. to 200° C.;
(γ) carbon disulfide and at least one alkylene oxide are added to the mixture resulting from step (β).

In a sixth embodiment the invention relates to a process according to the fifth embodiment, wherein in step (γ) carbon disulfide and the at least one alkylene oxide are continuously metered into the mixture resulting from step (β).

In a seventh embodiment the invention relates to a process according to either of the fifth and sixth embodiments, wherein step (γ) is performed at 50° C. to 150° C., preferably at 60° C. to 145° C., particularly preferably at 70° C. to 140° C. and very particularly preferably at 90° C. to 130° C.

In an eighth embodiment the invention relates to a process according to any of the first to fourth embodiments, wherein in step

(α′) a reactor is initially charged with the double metal cyanide catalyst and the at least H-functional starter compound and/or a suspension medium which does not comprise H-functional groups and an inert gas is passed through the reactor at a temperature of 50° C. to 200° C. and simultaneously by removing the inert gas a reduced (absolute) pressure of 10 mbara to 800 mbara in the reactor is established;
(β′) the mixture from step (α) is admixed with a portion (based on the entirety of the amount of alkylene oxides employed in steps (β′) and (γ′)) of the at least one alkylene oxide at temperatures of 50° C. to 200° C. and subsequently the addition of the at least one alkylene oxide is interrupted;
(γ′) at least one alkylene oxide, carbon disulfide and at least one H-functional starter compound and optionally also double metal cyanide catalyst is continuously metered into the reactor.

In a ninth embodiment the invention relates to a process according to the eighth embodiment, wherein

(α′) a reactor is initially charged with the double metal cyanide catalyst a suspension medium which does not comprise H-functional groups and an inert gas is passed through the reactor at a temperature of 50° C. to 200° C. and simultaneously by removing the inert gas a reduced (absolute) pressure in the reactor of 10 mbara to 800 mbara is established.

In a tenth embodiment the invention relates to a process according to the either of the seventh and eighth embodiments, wherein in step (γ′) the metered addition of the at least one H-functional starter compound is terminated before the addition of the at least one alkylene oxide.

In an eleventh embodiment the invention relates to a process according to any of the eighth to tenth embodiments, wherein step (γ) is performed at 50° C. to 150° C., preferably at 60° C. to 145° C., particularly preferably at 70° C. to 140° C. and very particularly preferably at 90° C. to 130° C.

In a twelfth embodiment the invention relates to a polyether thiocarbonate polyol obtainable by a process according to any of the first to eleventh embodiments, wherein the total content of the functional group:

—S—C(═O)—

in the polymer is ≤21 mol %.

In a thirteenth embodiment the invention relates to a polyether thiocarbonate polyol according to the twelfth embodiment having a refractive index no (20° C.) of ≥1.45.

In a fourteenth embodiment the invention relates to a polyurethane polymer obtainable from the reaction of a polyol component comprising a polyether thiocarbonate polyol according to the twelfth or thirteenth embodiment with at least one polyisocyanate component.

In a fifteenth embodiment the invention relates to a polyurethane polymer according to the fourteenth embodiment, wherein the polyurethane polymer is a polyurethane foam.

In a sixteenth embodiment the invention relates to a process according to any of the fifth to seventh embodiments, wherein the product is withdrawn after termination of step (γ).

In a seventeenth embodiment the invention relates to a process according to any of the fifth to seventh embodiments, wherein the product is withdrawn continuously in step (β) and/or step (γ), preferably in step (β) and/or step (γ).

In an eighteenth embodiment the invention relates to a process according to any of the eighth to eleventh embodiments, wherein the product is withdrawn after termination of step (γ′).

In a ninteenth embodiment the invention relates to a process according to any of the eighth to eleventh embodiments, wherein the product is withdrawn continuously in step (β′) and/or step (γ′), preferably in step (β′) and/or step (γ′).

### EXAMPLES

The invention is more particularly described with reference to the examples which follow but without any intention to limit the invention thereto.

H-functional starter compounds (starters) used:

PET-1 difunctional poly(oxypropylene)polyol having an OH number of 112 mg_{KOH}/g
PET-2 trifunctional poly(oxypropylene)polyol having an OH number of 240 mg_{KOH}/g

The DMC catalyst was prepared according to example 6 of WO-A 01/80994.

The 300 ml pressure reactor used in the examples had an (internal) height of 10.16 cm and an internal diameter of 6.35 cm. The reactor was equipped with an electrical heating jacket (510 watt maximum heating power). The counter-cooling consisted of an immersed tube of external diameter 6 mm which had been bent into a U shape and which projected into the reactor up to 5 mm above the base, and through which cooling water flowed at about 10° C. The water flow was switched on and off by means of a magnetic valve. In addition, the reactor was equipped with an inlet tube and a thermal sensor of diameter 1.6 mm, which both projected into the reactor up to 3 mm above the base.

The heating power of the electrical heating jacket during activation [step (β)] was on average about 20% of the maximum heating power. As a result of the adjustment, the heating power varied by ±5% of the maximum heating power. The occurrence of increased evolution of heat in the reactor, brought about by the rapid reaction of propylene oxide during the activation of the catalyst [step (β)], was observed via reduced heating power of the heating jacket, engagement of the counter-cooling, and, as the case may be, a temperature increase in the reactor. The occurrence of evolution of heat in the reactor, brought about by the continuous reaction of propylene oxide during the reaction [step (γ)], led to a fall in the power of the heating jacket to about 8% of the maximum heating power. As a result of the adjustment, the heating power varied by ±5% of the maximum heating power.

The hollow-shaft stirrer used in the examples was a hollow-shaft stirrer where the gas was introduced into the reaction mixture via a hollow shaft in the stirrer. The stirrer body mounted on the hollow shaft comprised four arms having a diameter of 35 mm and a height of 14 mm. The arm was equipped at each end with two gas outlets of 3 mm in diameter. The turning stirrer created a negative pressure such that the gas above the reaction mixture was sucked away and was introduced into the reaction mixture via the hollow shaft of the stirrer.

The copolymerization of propylene oxide and CS₂ resulted not only in the cyclic propylene thiocarbonate but also in the polyether thiocarbonate polyol containing polythiocarbonate units (—S(C═S)—) shown in formula (X)

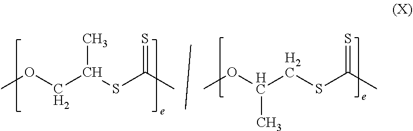

and also polythiocarbonate units (—S(C═O)—) shown in formula (XI):

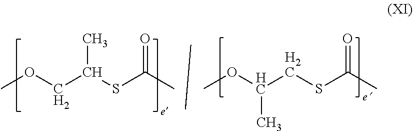

The copolymerization of propylene oxide and CS₂ resulted not only in the cyclic propylene thiocarbonate but also in the polyether thiocarbonate polyol additionally containing polyether units shown in formula (XII)

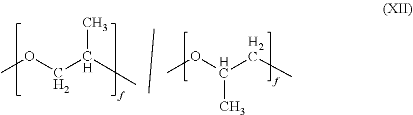

Characterization of the reaction mixture was by ¹H NMR spectroscopy, IR spectroscopy and gel permeation chromatography.

The ratio of the amount of cyclic propylene thiocarbonate to polyether thiocarbonate polyol (selectivity) and the molar ratio of thiocarbonate groups to ether groups in the polyether thiocarbonate polyol (e/f ratio) and the proportion of converted propylene oxide (C in mol %) were determined by ¹H NMR spectroscopy. Each sample was dissolved in deuterated chloroform and analyzed on a Bruker spectrometer (AV400, 400 MHz). The relevant resonances in the ¹H NMR spectrum (based on TMS=0 ppm) which were used for integration are as follows:
I1: 1.11-1.16: CH₃ group of the polyether units, of the polythiocarbonate units and of the polythiocarbonate units (—S(C═O)—), area of resonance corresponds to three H atoms
I2: 1.53-1.55: CH₃ group of the cyclic monothiocarbonate, area of resonance corresponds to three H atoms
I3: 1.64-1.66: CH₃ group of the cyclic thiocarbonate, area of resonance corresponds to three H atoms
I4: 4.47-4.58: CH₂ group of the polythiocarbonate units, area of resonance corresponds to two H atoms
I5: 5.10-5.12: CH group of the polythiocarbonate units (—S(C═O)—), area of resonance corresponds to one H atom
I6: 5.77-5.81: CH group of the polythiocarbonate units, area of resonance corresponds to one H atom

Reported are the molar ratio of the amount of linear polyether thiocarbonate polyol (P mol %) to cyclic thiocarbonate based on the sum of the amount of propylene oxide employed during activation and copolymerization and the molar ratio of thiocarbonate groups (—S(C═S)—) to thiocarbonate groups (—S(C═O)—) in the polyether thiocarbonate polyol.

Taking account of the relative intensities, the values were calculated as follows:

Polyether thiocarbonate polyol (P mol %)=[((I1/3)/((I1/3)+(I2/3+(I3/3))]*100%

Molar ratio of thiocarbonate groups (—S(C═S)—) to thiocarbonate groups (—S(C═O)—) in the polyether thiocarbonate polyol:

e/e′=(I4/2)+(I6))/I5

Proportion of thiocarbonate groups (—S(C═S)—) resulting from incorporation of carbon disulfide in the repeating units of the polyether thiocarbonate polyol:

thiocarbonate groups (—S(C═S)—) mol %=[((I4/2)+(I6))/((I4/2)+I5+I6)]*100%

Proportion of thiocarbonate groups (—S(C═O)—) resulting from incorporation of carbon disulfide in the repeating units of the polyether thiocarbonate polyol:

thiocarbonate groups (—S(C═O)—) mol %=[(I5/((I4/2)+I5+I6)]*100%

The number-average Mₙ and the weight-average M_{w} of the molecular weight of the resulting polymers was determined by gel permeation chromatography (GPC). The procedure of DIN 55672-1 was followed: “Gel permeation chromatography, Part 1—Tetrahydrofuran as eluent” (SECurity GPC System from PSS Polymer Service, flow rate 1.0 mL/min; columns: 2×PSS SDV linear M, 8×300 mm, 5 μm; RID detector). Polystyrene samples of known molar mass were used for calibration.

The OH number (hydroxyl number) was determined based on DIN 53240-2 but using N-methylpyrrolidone rather than THF/dichloromethane as solvent. A 0.5 molar ethanolic KOH solution was used for titration (endpoint recognition by potentiometry). The test substance used was castor oil with certified OH number. The reporting of the unit in “mg/g” relates to mg[KOH]/g[polyether thiocarbonate polyol].

Viscosity was determined on an Anton Paar Physica MCR 501 rheometer. A cone-plate configuration having a separation of 1 mm was selected (DCP25 measurement system). The polythioether carbonate polyol (0.1 g) was applied to the rheometer plate and subjected to a shear of 0.01 to 1000 l/s at 25° C. and the viscosity was measured every 10 s for 10 min. The viscosity averaged over all measurement points is reported.

For rheological determination of the gel point for the polyurethane polymer the polythioether carbonate polyols were admixed with an equimolar amount of Desmodur N3300 (hexamethylene diisocyanate trimer) and 2000 ppm of dibutyltin laurate (2% in diphenyl ether). The complex moduli G′ (storage modulus) and G″ (loss modulus) were determined in an oscillation measurement at 40° C. and a frequency of 1 Hz, using a plate/plate configuration with a plate diameter of 15 mm, a plate-to-plate distance of 1 mm, and a 10 percent deformation. The gel point was defined as time at which G′=G″.

The proportion of sulfur atoms (S wt %) in the polyether thiocarbonate polyol was determined using elemental analysis. Analysis in the Leco “CHN628” instrument is based on combustion at 950° C. (afterburning space 850° C.) in a pure oxygen stream and subsequent analysis in a stream of helium as carrier gas. Analysis is effected based on the standards DIN 51732 and DIN EN ISO 16948. The sulfur content is determined based on DIN CENTS 15289 after combustion of the sample in the oxygen stream and drying of the combustion gas by means of infrared cells.

The refractive index of polyether thiocarbonate polyols was determined using an AR4 Abbe refractometer from A.KRÜSS Optronic GmbH.

IR spectroscopy: FT-IR Spectra were recorded using a Bruker Alpha-P FT-IR Spectrometer (Bruker Optics), equipped with a diamond head. All samples were recorded in a range of 4000-400 cm⁻¹ with 24 scans at a resolution of 4 cm⁻¹. The spectra were evaluated using OPUS 7.0 software (Bruker Optics).

The following examples 1 to 4 were performed with PET-1 as the starter. The values for pressure refer to the absolute pressure.

### Example 1: Polymerisation of Propylene Oxide and CS₂ with a DMC Catalyst Dried Under Argon and Activated in an Ar Atmosphere in a Semi-Batch Process with Addition of CS2 in Step γ

### [First Activation Stage, Step (α)]

A 300 ml pressure reactor fitted with a hollow-shaft stirrer was initially charged with a mixture of DMC catalyst (18 mg) and PET-1 (20 g). The reactor was sealed and the pressure in the reactor reduced to 5 mbara for five minutes. The pressure in the reactor was then adjusted to 50 mbara by application of a light Ar stream and simultaneous removal of the gas with a pump. The reactor was heated to 130° C. and the mixture was stirred (800 rpm) at 130° C. under reduced pressure (50 mbara) and a light Ar stream for 30 minutes.

### [Second Activation Stage, Step (β)]

A pressure of 2 bara of Ar was established. 2 g of propylene oxide were metered in using an HPLC pump (1.0 mL/min) and the reaction mixture was stirred (800 rpm) for 20 min. Subsequently, two further portions of propylene oxide of 2 g each were metered in by means of the HPLC pump (1.0 mL/min) and the reaction mixture was stirred (800 rpm) for 20 min in each case. The occurrence of a brief increase in evolution of heat in the reactor during this time confirmed the activation of the catalyst.

### [Polymerisation Stage, Step (γ)]

After cooling to 110° C., a further 34 g of propylene oxide were metered in by means of an HPLC pump (1.0 ml/min) with continued stirring. 4 min after commencement of the addition of propylene oxide, 15 g of CS₂ were simultaneously metered in by means of an HPLC pump (0.5 mL/min). The reaction mixture was subsequently stirred at 110° C. for a further 1 h. The reaction was stopped by cooling the reactor with ice water, the positive pressure was released and the resulting product analyzed.

The NMR spectroscopic analysis of the reaction mixture showed full conversion of the propylene oxide.

The selectivity for linear polyether thiocarbonate polyol over cyclic thiocarbonate was ≥99%.

The molar ratio of thiocarbonate groups (—S(C═S)—) to thiocarbonate groups (—S(C═O)—) in the polyether thiocarbonate polyol was 3.9.

The proportion of sulfur atoms (wt %) in the polyether thiocarbonate polyol was 6.2 wt %.

The obtained polyether thiocarbonate polyol had a molecular weight Mₙ=3411 g/mol, M_{w}=5798 g/mol and a polydispersity of 1.7.

The OH number of the resulting mixture was 44.0 mg_{KOH}/g.

The refractive index of the obtained polyether thiocarbonate polyol was 1.51.

The time until attainment of the gel point for the polyurethane polymer was 8.2 min.

### Example 2: Polymerisation of Propylene Oxide and CS2 with a DMC Catalyst Dried Under Argon and Activated in an Ar Atmosphere in a Semi-Batch Process

### [First Activation Stage, Step (α)]

A 300 ml pressure reactor fitted with a hollow-shaft stirrer was initially charged with a mixture of DMC catalyst (18 mg) and PET-1 (20 g). The reactor was sealed and the pressure in the reactor reduced to 5 mbara for five minutes. The pressure in the reactor was then adjusted to 50 mbara by application of a light Ar stream and simultaneous removal of the gas with a pump. The reactor was heated to 130° C. and the mixture was stirred (800 rpm) at 130° C. under reduced pressure (50 mbara) and a light Ar stream for 30 minutes.

### [Second Activation Stage, Step (β)]

A pressure of 2 bara of Ar was established. 2 g of propylene oxide were metered in using an HPLC pump (1.0 mL/min) and the reaction mixture was stirred (800 rpm) for 20 min. Subsequently, two further portions of propylene oxide of 2 g each were metered in by means of the HPLC pump (1.0 mL/min) and the reaction mixture was stirred (800 rpm) for 20 min in each case. The occurrence of a brief increase in evolution of heat in the reactor during this time confirmed the activation of the catalyst.

### [Polymerisation Stage, Step (γ)]

After cooling to 110° C., 15 g of CS₂ were metered in by means of an HPLC pump (2.0 ml/min) with continued stirring. After the addition of CS₂, 34 g of propylene oxide were metered in by means of an HPLC pump (1 mL/min). The reaction mixture was subsequently stirred at 110° C. for a further 1 h. The reaction was stopped by cooling the reactor with ice water, the positive pressure was released and the resulting product analyzed.

The NMR spectroscopic analysis of the reaction mixture showed full conversion of the propylene oxide.

The selectivity for linear polyether thiocarbonate polyol over cyclic thiocarbonate was ≥99%.

The molar ratio of thiocarbonate groups (—S(C═S)—) to thiocarbonate groups (—S(C═O)—) in the polyether thiocarbonate polyol was 8.9.

The proportion of sulfur atoms (wt %) in the polyether thiocarbonate polyol was 3.7 wt %.

The obtained polyether thiocarbonate polyol had a molecular weight Mₙ=3116 g/mol, M_{w}=6232 g/mol and a polydispersity of 2.0.

The OH number of the resulting mixture was 42.6 mg_{KOH}/g.

The refractive index of the obtained polyether thiocarbonate polyol was 1.46.

The time until attainment of the gel point for the polyurethane polymer was 6.3 min.

### Example 3 (Comparative): Preparation of a Polyether Thiocarbonate Polyol Via a Semi-Batch Process with Addition of CS2 in Step α

### [First Activation Stage, Step (α)]

A 300 ml pressure reactor fitted with a sparging stirrer was initially charged with a mixture of DMC catalyst (18 mg), PET-1 (20 g) and CS₂ (15 g). The reactor was sealed and the pressure in the reactor reduced to 5 mbara for five minutes. The pressure in the reactor was then adjusted to 50 mbara by application of a light Ar stream and simultaneous removal of the gas with a pump. The reactor was heated to 130° C. and the mixture was stirred (800 rpm) at 130° C. under reduced pressure (50 mbara) and a light Ar stream for 30 minutes.

### [Second Activation Stage, Step (β)]

A pressure of 2 bara of Ar was established. 2 g of propylene oxide were metered in using an HPLC pump (1.0 mL/min) and the reaction mixture was stirred (800 rpm) for 20 min. Subsequently, two further portions of propylene oxide of 2 g each were metered in by means of the HPLC pump (1.0 mL/min) and the reaction mixture was stirred (800 rpm) for 20 min in each case. The occurrence of a brief increase in evolution of heat in the reactor during this time confirmed the activation of the catalyst.

### [Polymerisation Stage, Step (γ)]

After cooling to 110° C., 34 g of propylene oxide were metered in by means of an HPLC pump (1.0 ml/min) with continued stirring. The reaction mixture was subsequently stirred at 110° C. for a further 1 h. The reaction was stopped by cooling the reactor with ice water, the positive pressure was released. No product was obtained.

### Example 4 (Comparative): Preparation of a Polyether Thiocarbonate Polyol Via a Semi-Batch Process with Addition of CS2 in Step β

### [First Activation Stage, Step (α)]

A 300 ml pressure reactor fitted with a hollow-shaft stirrer was initially charged with a mixture of DMC catalyst (18 mg) and PET-1 (20 g). The reactor was sealed and the pressure in the reactor reduced to 5 mbara for five minutes. The pressure in the reactor was then adjusted to 50 mbara by application of a light Ar stream and simultaneous removal of the gas with a pump. The reactor was heated to 130° C. and the mixture was stirred (800 rpm) at 130° C. under reduced pressure (50 mbara) and a light Ar stream for 30 minutes.

### [Second Activation Stage, Step (β)]

A pressure of 2 bara of Ar was established. 15 g of CS₂ were metered in via an HPLC pump (2.0 mL/min) with continued stirring and a slight temperature drop was apparent. Once a temperature of 130° C. had been reestablished, 2 g of propylene oxide were metered in using an HPLC pump (1.0 mL/min) and the reaction mixture was stirred (800 rpm) for 20 min. Subsequently, two further portions of propylene oxide of 2 g each were metered in by means of the HPLC pump (1.0 mL/min) and the reaction mixture was stirred (800 rpm) for 20 min in each case. The occurrence of a brief increase in evolution of heat in the reactor during this time confirmed the activation of the catalyst.

### [Polymerisation Stage, Step (γ)]

After cooling to 110° C., 34 g of propylene oxide were metered in by means of an HPLC pump (1.0 ml/min) with continued stirring. The reaction mixture was subsequently stirred at 110° C. for a further 1 h. The reaction was stopped by cooling the reactor with ice water, the positive pressure was released. No product was obtained.

TABLE 1
Overview of results for preparation of polyether thiocarbonate polyols with variation of
the time of addition of carbon disulfide in a semi-batch process

| | Time | | | | | | |
|---|---|---|---|---|---|---|---|
| | of | | | | | Proportion of | |
| | addition | n(PO)/ | Selectivity | | | sulfur | Refractive |
| Ex- | of CS₂ | n(CS2) | for PETC^{b)} | S(—S(C═S)—) | S(—S(C═O)—) | atoms | index |
| ample^{a)} | [−] | [mol/mol] | [mol %] | [mol %] | [mol %] | [wt %] | [−] |
| 1 | [step γ] | 3.5 | ≥99% | 79.9 | 20.1 | 6.2 | 1.51 |
| 2 | [step γ] | 3.5 | ≥99% | 89.9 | 10.1 | 3.7 | 1.46 |
| 3 | [step α] | 3.5 | No product was obtained. | | | | |
| (comp.) | | | | | | | |
| 4 | [step β] | 3.5 | No product was obtained. | | | | |
| (comp.) | | | | | | | |

^{a)}comp.: comparative example, PETC: ^{b)}linear polyether thiocarbonate polyol,

Examples 1 and 2 and comparative examples 3 and 4 show that in the case of addition of carbon disulfide in the polymerization stage (step γ) (example 1-2) the carbon disulfide is incorporated into the polymer while by contrast in the case of addition of carbon disulfide only during the first activation stage (step α) (comparative example 3) or the second activation stage (step β) (comparative example 4) no product is obtained. Likewise, the refractive index of the polymer increases with an increased proportion of incorporated carbon disulfide in the polyether thiocarbonate polyol (examples 1-2). The linear polyether thiocarbonate polyol is likewise obtained in high selectivity over cyclic thiocarbonate and the obtained polyol has a higher ratio of thiocarbonate groups (—S(C═S)—) to thiocarbonate groups (—S(C═O)—) (examples 1-2).

### Example 5: Variation of the Starter Polyol Through Use of PET-2 Instead of PET-1 (n(PO)/n(CS2)=3.7)

Employed in a procedure analogous to example 1 were: PET-2 starter (20 g); DMC catalyst (18 mg); propylene oxide (2+2+2 g in step (B)+36 g in step (γ), 42 g altogether); CS2 (0.5 mL/min=15 g); catalyst activation as described; argon stripping (50 mbara); activation temperature=130° C.; reaction temperature=110° C.; postreaction time=1 h. The reaction was stopped by cooling the reactor with ice water, the positive pressure was released and the resulting product analyzed.

The NMR spectroscopic analysis of the reaction mixture showed full conversion of the propylene oxide.

The selectivity of linear polyether thiocarbonate polyol to cyclic thiocarbonate was ≥99%.

The molar ratio of thiocarbonate groups (—S(C═S)—) to thiocarbonate groups (—S(C═O)—) in the polyether thiocarbonate polyol was 7.3%.

The proportion of sulfur atoms (wt %) in the polyether thiocarbonate polyol was 6.4 wt %.

The obtained polyether thiocarbonate polyol had a molecular weight Mₙ=3430 g/mol, M_{w}=6517 g/mol and a polydispersity of 1.9.

The OH number of the resulting mixture was 54.7 mg_{KOH}/g.

The refractive index of the obtained polyether thiocarbonate polyol was 1.54.

The time until the attainment of the gel point for the polyurethane polymer was 2.0 min.

### Example 6: Copolymerization of Styrene Oxide and CS₂ (n(SO)/n(CS2)=1.8)

Employed in a procedure analogous to example 1 were: PET-1 starter (20 g); DMC catalyst (18 mg, 300 ppm); styrene oxide (2+2+2 g in step (13)+36 g in step (γ), 42 g altogether); CS₂ (0.5 mL/min=15 g); catalyst activation as described; argon stripping (50 mbara); activation temperature=130° C.; reaction temperature=110° C.; postreaction time=1 h. A polyether thiocarbonate polyol having a viscosity of. 9.22 Pa·s was obtained.

### Example 7: Polymerisation of Propylene Oxide and CS2 with a DMC Catalyst Dried Under Argon and Activated in an Ar Atmosphere in a Semi-Batch CAOS Process

### [First Activation Stage, Step (α)]

A 970 mL pressure reactor fitted with a sparging stirrer was initially charged with a mixture of DMC catalyst (30.0 mg) and toluene (175 mL) and the reaction mixture was stirred (800 rpm) for 30 min at 130° C.

### [Second Activation Stage, Step (β)]

A pressure of 2 bar of Ar was established. 2.5 g of propylene oxide were metered in using an HPLC pump (3.0 mL/min) and the reaction mixture was stirred (800 rpm) for 20 min. Subsequently, two further portions of propylene oxide of 2.5 g each were metered in by means of the HPLC pump (3.0 mL/min) and the reaction mixture was stirred (800 rpm) for 20 min in each case. The occurrence of a brief increase in evolution of heat in the reactor during this time confirmed the activation of the catalyst.

### [Polymerisation Stage, Step (γ)]

The temperature was readjusted to 110° C. and a further 77.4 g of propylene oxide were metered in by means of an HPLC pump (1.25 mL/min) with stirring, with continued stirring of the reaction mixture (800 rpm). Three minutes after commencement of the addition of propylene oxide (3.0), 4.5 g of dipropylene glycol were metered in by means of a separate HPLC pump (0.18 mL/min) with stirring. 15 min after commencement of the addition of propylene oxide (15.0 g), 10.0 g of CS₂ were simultaneously metered in by means of a separate HPLC pump (0.13 mL/min). After the addition of propylene oxide had ended, the reaction mixture was stirred at 110° C. for a further 30 min. The reaction was stopped by cooling the reactor with ice water, the positive pressure was released and the resulting product analyzed.

The NMR spectroscopic analysis of the reaction mixture showed full conversion of the propylene oxide.

The selectivity for linear polyether thiocarbonate polyol over cyclic thiocarbonate was ≥99%.

The molar ratio of thiocarbonate groups (—S(C═S)—) to thiocarbonate groups (—S(C═O)—) in the polyether thiocarbonate polyol was 13.5.

The proportion of sulfur atoms (wt %) in the polyether thiocarbonate polyol was 2.1 wt %.

The obtained polyether thiocarbonate polyol had a molecular weight Mₙ=2918 g/mol, M_{w}=5798 g/mol and a polydispersity of 1.81.

The OH number of the resulting mixture was 40.3 mg_{KOH}/g.

### Example 8 (Comparative): Polymerisation of Propylene Oxide and CS2 with a DMC Catalyst Dried Under Argon and Activated in an Ar Atmosphere in a Semi-Batch CAOS Process with Addition of CS₂ in Step α

### [First Activation Stage, Step (α)]

A 970 mL pressure reactor fitted with a sparging stirrer was initially charged with a mixture of DMC catalyst (30.0 mg), toluene (175 mL) and CS₂ (10.0 g) and the reaction mixture was stirred (800 rpm) for 30 min at 130° C.

### [Second Activation Stage, Step (β)]

A pressure of 2 bar of Ar was established. 2.5 g of propylene oxide were metered in using an HPLC pump (3.0 mL/min) and the reaction mixture was stirred (800 rpm) for 20 min. Subsequently, two further portions of propylene oxide of 2.5 g each were metered in by means of the HPLC pump (3.0 mL/min) and the reaction mixture was stirred (800 rpm) for 20 min in each case. The occurrence of a brief increase in evolution of heat in the reactor during this time confirmed the activation of the catalyst.

### [Polymerisation Stage, Step (γ)]

The temperature was readjusted to 110° C. and a further 77.4 g of propylene oxide were metered in by means of an HPLC pump (1.25 mL/min) with stirring, with continued stirring of the reaction mixture (800 rpm). Three minutes after commencement of the addition of propylene oxide (3.0), 4.5 g of dipropylene glycol were metered in by means of a separate HPLC pump (0.18 mL/min) with stirring. After the addition of propylene oxide had ended, the reaction mixture was stirred at 110° C. for a further 30 min. The reaction was stopped by cooling the reactor with ice water, the positive pressure was released. No product was obtained.

### Example 9 (Comparative): Polymerisation of Propylene Oxide and CS2 with a DMC Catalyst Dried Under Argon and Activated in an Ar Atmosphere in a Semi-Batch CAOS Process with Addition of CS₂ in Step β

### [First Activation Stage, Step (α)]

A 970 mL pressure reactor fitted with a sparging stirrer was initially charged with a mixture of DMC catalyst (30.0 mg), toluene (175 mL) and CS₂ (10.0 g) and the reaction mixture was stirred (800 rpm) for 30 min at 130° C.

### [Second Activation Stage, Step (β)]

A pressure of 2 bar of Ar was established. 10.0 g of CS₂ were metered in via an HPLC pump (2.0 mL/min) with continued stirring and a slight temperature drop was apparent. Once a temperature of 130° C. had been reestablished, 2.5 g of propylene oxide were metered in using an HPLC pump (1.0 mL/min) and the reaction mixture was stirred (800 rpm) for 20 min. Subsequently, two further portions of propylene oxide of 2.5 g each were metered in by means of the HPLC pump (1.0 mL/min) and the reaction mixture was stirred (800 rpm) for 20 min in each case. The occurrence of a brief increase in evolution of heat in the reactor during this time confirmed the activation of the catalyst.

### [Polymerisation Stage, Step (γ)]

The temperature was readjusted to 110° C. and a further 77.4 g of propylene oxide were metered in by means of an HPLC pump (1.25 mL/min) with stirring, with continued stirring of the reaction mixture (800 rpm). Three minutes after commencement of the addition of propylene oxide (3.0), 4.5 g of dipropylene glycol were metered in by means of a separate HPLC pump (0.18 mL/min) with stirring. After the addition of propylene oxide had ended, the reaction mixture was stirred at 110° C. for a further 30 min. The reaction was stopped by cooling the reactor with ice water, the positive pressure was released. No product was obtained.

TABLE 2
Overview of results for preparation of polyether thiocarbonate polyols with
variation of the time of addition of carbon disulfide in a semi-batch CAOS process

| | Time | | | | | | |
|---|---|---|---|---|---|---|---|
| | of | | | | | Proportion | |
| | addition | n(PO)/ | Selectivity | | | of sulfur | Refractive |
| Ex- | of CS₂ | n(CS2) | for PETC^{b)} | S(—S(C═S)—O) | S(—S(C═O)—) | atoms | index |
| ample^{a)} | [−] | [mol/mol] | [mol %] | [mol %] | [mol %] | [wt %] | [−] |
| 7 | [step γ] | 11.1 | ≥99% | 93.1 | 6.9 | 2.1 | 1.47 |
| 8 | [step α] | 11.1 | No product was obtained. | | | | |
| (comp.) | | | | | | | |
| 9 | [step β] | 11.1 | No product was obtained. | | | | |
| (comp.) | | | | | | | |

^{a)}comp.: comparative example, PETC: ^{b)}linear polyether thiocarbonate polyol,

Example 7 and comparative examples 8-9 show that in the case of addition of carbon disulfide in the polymerization stage (step γ) (example 7) the carbon disulfide is incorporated into the polymer while by contrast in the case of addition of carbon disulfide only during the first activation stage (step α) (comparative example 8) or the second activation stage (step β) (comparative example 9) no product is obtained. Likewise, the refractive index of the polymer increases with an increased proportion of incorporated carbon disulfide in the polyether thiocarbonate polyol (examples 7). The linear polyether thiocarbonate polyol is likewise obtained in high selectivity over cyclic thiocarbonate and the obtained polyol has a higher ratio of thiocarbonate groups (—S(C═S)—) to thiocarbonate groups (—S(C═O)—) (examples 7).

1. A process for preparing polyether thiocarbonate polyols comprising reacting carbon disulfide and at least one alkylene oxide in the presence of a double metal cyanide catalyst and at least one H-functional starter compound, wherein
the double metal cyanide catalyst has previously been contacted with at least one alkylene oxide before contacting with carbon disulfide.

2. The process according to claim 1, wherein the at least one alkylene oxide comprises at least one of ethylene oxide, propylene oxide and styrene oxide.

3. The process according to claim 1, wherein the at least one H-functional starter compound comprises at least one of a polyether polyol, a polyester polyol, a polyether ester polyol, a polyether carbonate polyol, a polycarbonate polyol, and a polyacrylate polyol.

4. The process according to claim 1, wherein the molar ratio of the at least one employed alkylene oxide to the employed carbon disulfide is in a range from ≥1:1 to ≤100:1.

5. The process according to claim 1 to 4, comprising
(α) initially charging a reactor with the double metal cyanide catalyst and the at least one H-functional starter compounds, passing an inert gas through the reactor at a temperature of 50° C. to 200° C., and simultaneously establishing a reduced (absolute) pressure in the reactor of 10 mbara to 800 mbara by removing the inert gas;
(β) admixing the mixture from (α) with a portion (based on the entirety of the amount of alkylene oxides employed in steps (β) and (γ)) of the at least one alkylene oxide at temperatures of 50° C. to 200° C.;
(γ) adding carbon disulfide and at least one alkylene oxide to the mixture resulting from (β).

6. The process according to claim 5, wherein carbon disulfide and the at least one alkylene oxide in (γ) are continuously metered into the mixture resulting from (β).

7. The process according to claim 5, wherein (γ) is performed at 50° C. to 150° C.

8. The process according to claim 1, comprising
(α′) initially charging a reactor with the double metal cyanide catalyst and the at least H-functional starter compound and/or a suspension medium which does not comprise H-functional groups, passing an inert gas through the reactor at a temperature of 50° C. to 200° C., and simultaneously establishing a reduced (absolute) pressure of 10 mbara to 800 mbara in the reactor by removing the inert gas;
(β′) admixing the mixture from (α′) with a portion (based on the entirety of the amount of alkylene oxides employed in steps (β′) and (γ′)) of the at least one alkylene oxide at temperatures of 50° C. to 200° C., and subsequently interrupting the addition of the at least one alkylene oxide;
(γ′) continuously metering at least one alkylene oxide, carbon disulfide, and at least one H-functional starter compound, and optionally double metal cyanide catalyst into the reactor during the reaction.

9. The process according to claim 8, comprising
(α′) initially charging a reactor with the double metal cyanide catalyst in a suspension medium which does not comprise H-functional groups, passing an inert gas through the reactor at a temperature of 50° C. to 200° C., and simultaneously establishing a reduced (absolute) pressure in the reactor of 10 mbara to 800 mbara by removing the inert gas.

10. The process according to claim 8, wherein in step (γ′) the metered addition of the at least one H-functional starter compound is terminated before the addition of the at least one alkylene oxide.

11. The process according to claim 8, wherein step (γ′) is performed at 50° C. to 150° C.

12. A polyether thiocarbonate polyol obtainable by a process according to claim 1, wherein the total content of the functional group:
—S—C(═O)—
in the polymer is ≤21 mol %.

13. The polyether thiocarbonate polyol according to claim 12 having a refractive index n_{D} (20° C.) of ≥1.45.

14. A polyurethane polymer obtainable from the reaction of a polyol component comprising the polyether thiocarbonate polyol according to claim 12 with at least one polyisocyanate component.

15. The polyurethane polymer according to claim 14, wherein the polyurethane polymer is a polyurethane foam.
